(19) United States
(12) Patent Application Publication
(10) Pub. No.: US 2015/0323667 A1
(43) Pub. Date: Nov. 12, 2015

(54) TIME OF FLIGHT RANGE FINDING WITH AN ADAPTIVE TRANSMIT PULSE AND ADAPTIVE RECEIVER PROCESSING

(71) Applicant: Chirp Microsystems, Berkeley, CA (US)

(72) Inventors: Richard Przybyla, Emeryville, CA (US); Andre Guedes, Berkeley, CA (US); Stefon Shelton, Oakland, CA (US); Meng-Hsiung Kiang, Albany, CA (US); David Horsley, Albany, CA (US)

(21) Appl. No.: 14/710,360

(22) Filed: May 12, 2015

Related U.S. Application Data
(60) Provisional application No. 61/991,704, filed on May 12, 2014.

(51) Int. Cl. G01S 15/10; G10K 11/34; G10K 11/26

(52) U.S. Cl. CPC G01S 15/10; G10K 11/26; G10K 11/346

(57) ABSTRACT

A rangefinding apparatus and method are disclosed. The apparatus may include at least one processor and memory operably connected to the at least one processor. The memory may store instructions that, when executed, cause the apparatus to iterate a target-acquisition process until a target is identified and then iterate a target-tracking process after the target has been identified. The target-acquisition process may include transmitting a short ultrasonic pulse, transmitting a long ultrasonic pulse, and listening for one or more echoes corresponding to the short or long ultrasonic pulses. The target-tracking process may include steering an optimized ultrasonic pulse toward the target, listening for an echo corresponding to the optimized ultrasonic pulse, and calculating, based on the echo, an updated location for the target.

### RELATED APPLICATIONS

This application claims the benefit of co-pending U.S. Provisional Patent Application Ser. No. 61/991,704 filed May 12, 2014, which is hereby incorporated by reference.

### STATEMENT REGARDING FEDERALLY SPONSORED RESEARCH OR DEVELOPMENT

This invention was made with Government support under IIP-1346158 awarded by the National Science Foundation. The Government has certain rights in this invention. See 45 CFR 650.4(f)(4).

### BACKGROUND

1. Field of the Invention

This invention relates to rangefinding and more particularly to systems and methods for using ultrasonic pulses to measure the range and/or direction to certain targets.

2. Background of the Invention

Time-of-flight (TOF) rangefinders emit pulses of electromagnetic or sound energy and analyze the echoes that are reflected back from a surrounding environment in order to measure the range and/or direction to certain objects or targets in that environment. The energy of the emitted pulses is critical to achieving an adequate signal-to-noise ratio (SNR) at the receiver. However, in certain applications, the available power for emitting such pulses is limited. In those applications, simply increasing the output power of the transmitter is not a viable solution. Accordingly, what is needed is a TOF rangefinder that measures the range and/or direction to certain targets while consuming very little power.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram illustrating one embodiment of a rangefinding system in accordance with the present invention;

FIG. 2 is a schematic block diagram illustrating certain sub-components of the rangefinding system of FIG. 1;

FIG. 3 is a schematic block diagram illustrating one embodiment of a method for transitioning between a target-acquisition process and a target-tracking process in accordance with the present invention;

FIG. 4 is a schematic illustration comprising a first plot showing the range of three example targets, a second plot showing a transmitted waveform and an echo from each of the three targets, and a third plot showing the transmitted waveform and the echo signal from the three targets after processing;

FIG. 5 is a schematic illustration showing a field of view being canvassed or illuminated via a first method by a system in accordance with the present invention;

FIG. 6 is a schematic illustration showing a field of view being canvassed or illuminated via a second, faster method by a system in accordance with the present invention;

FIG. 7 is a schematic illustration of a plot showing the relative changes in value of the component angles as the method of FIG. 6 is performed;

FIG. 8 is a schematic illustration of a plot showing the propagation of a pulse through an environment;

FIG. 9 is a schematic illustration of a plot showing the how the locations and detection status of various targets may change over time; and

FIG. 10 is a schematic block diagram illustrating one embodiment of method for tracking objects in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for rangefinding and target tracking and, more particularly, for pulse-echo rangefinding and target tracking that increase the energy of the reflected signal received by the rangefinder.

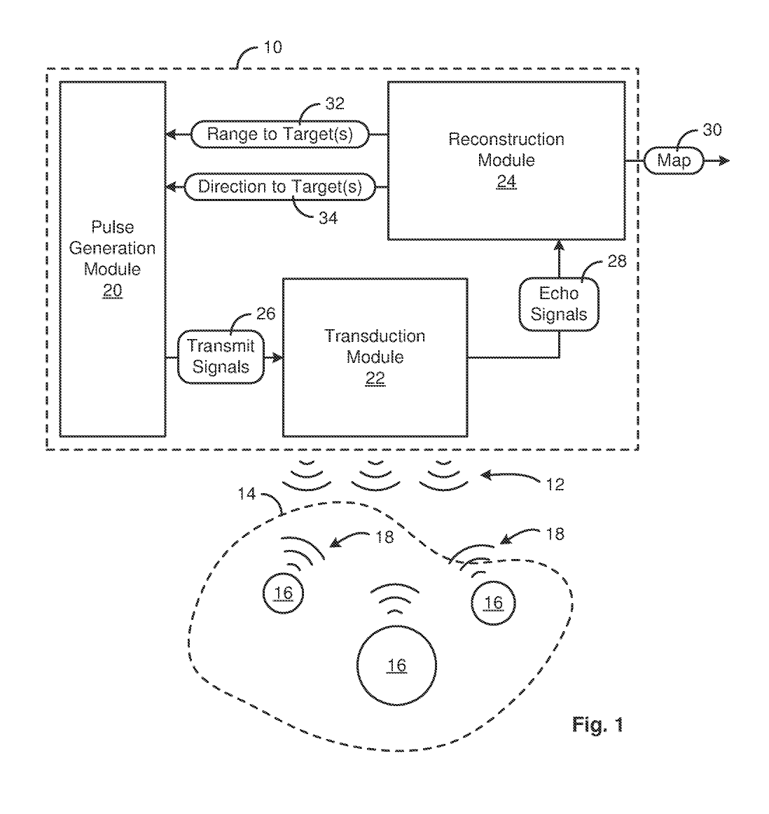

Referring to FIG. 1, a system 10 in accordance with the present invention may emit a pulse 12 of ultrasonic energy toward or into a scene 14 or adjacent environment 14. The emitted pulse 12 may travel toward one or more objects 16 or targets 16 in the scene 14. Accordingly, when the emitted pulse 12 reaches or impacts such targets 16, an echo 18 may be generated. The echo 18 may travel back to a system 10. Accordingly, a system 10 may analyze the echo in order to learn about the one or more targets 16. For example, a system 10 may learn the range and/or direction to the one or more targets 16.

In certain embodiments, the one or more targets 16 in a scene 14 may correspond to one or more body parts of a human user. For example, one target 16 may be the hand of a user. Alternatively, or in addition thereto, each finger or finger tip on the hand of a user may be a distinct target 16. Thus, the granularity or resolution produced by a system 10 with respect to the range and/or direction to the one or more targets 16 may be adapted to the intended use of that range and/or direction information.

A scene 14 may define or correspond to the area (e.g., three-dimensional space) in which a system 10 in accordance with the present invention may discern a target 16. Accordingly, different systems 10 may correspond to scenes 14 of different dimensions. For example, in selected embodiments, a system 10 may correspond to a scene 14 having a maximum depth of about 1 meter. In other embodiments, a system 10 may correspond to a scene 14 having a maximum depth of about 5 meters.

In selected embodiments, a system 10 in accordance with the present invention may include a pulse generation module 20, a transduction module 22, a reconstruction module 24, or a combination or sub-combination thereof. A pulse generation module 20 may generate and output one or more transmit signals 26. The one or more transmit signals 26 may be passed from a pulse generation module 20 to a transduction module 22.

A transduction module 22 may be a transmitter-receiver or a transceiver of ultrasonic energy. Accordingly, in a transmit mode or operation, a transduction module 22 may convert one or more transmit signals 26 into one or more pulses 12 of ultrasonic energy. Thus, the one or more transmit signals 26 may define or drive the emitted pulses 12. Conversely, in a receive mode or operation, a transduction module 22 may convert one or more ultrasonic echoes 18 into one or more echo signals 28. A transduction module 22 may pass the echo signals 28 to a reconstruction module 24 for analysis.

A reconstruction module 24 in accordance with the present invention may measure the time-of-flight (TOF) corresponding to the echo signals 28 in order to calculate the range and/or direction to one or more targets 16 in a scene 14. A reconstruction module 24 may output a map 30 (e.g., a range map 30) representing or communicating the three-dimensional locations of one or more targets 16 in a scene 14. The map 30 may be used as desired. For example, the map 30 may be used by gesture recognition software to discern user input.

In selected embodiments, estimated range and/or direction information 32, 34 calculated by a reconstruction module 24 may be passed to a pulse generation module 20. A pulse generation module 20 may use that information 32, 34 to generate and output transmit signals 26 that provide increased ultrasonic energy to the locations of the one or more targets 16 identified.

For example, certain transmit signals 26 may be coded to generate a pulse 12 that propagates primarily in the direction of a target 16. Alternatively, or in addition thereto, certain transmit signals 26 may be coded to generate a pulse 12 having desirable autocorrelation properties and a duration proportional to the range to a target 16. Accordingly, a system 10 in accordance with the present invention may quickly optimize or improve the accuracy of the map 30 and estimated range and/or direction information 32, 34 calculated by a reconstruction module 24.

In certain embodiments, a reconstruction module 24 may use estimated range and/or direction information 32, 34 to configure the signal processing performed therewithin to optimize noise and interference filtering when processing subsequent echo signals 28. This may be considered adaptive processing or an adaptive rangefinding process. Accordingly, when certain information 32, 34 about selected targets 16 is already known, a reconstruction module 24 may perform an adaptive rangefinding process. When no information 32, 34 about any targets 16 is known, a reconstruction module 24 may perform a non-adaptive rangefinding process.

In additional to certain other hardware, a system 10 in accordance with the present invention may include memory and one or more processors operably connected to run software (e.g., execute instructions) stored in that memory. In certain embodiments, the one or more processors may be multi-purpose processors. That is, the one or more processors may perform certain computational tasks in addition to those required by a system 10. For example, one or more processors may both perform computation corresponding to a system 10 and run gesture recognition software that utilizes a map 30 output by the system 10.

Alternatively, the one or more processors of a system 10 may be dedicated processors. That is, the one or more processors may only perform computation corresponding to a system 10. For example, one or more of a pulse generation module 20, transduction module 22, and reconstruction module 24 may each comprise a processor dedicated to performing the computation corresponding thereto. Alternatively, one or more processors may be dedicated to the computational tasks of a pulse generation module 20, transduction module 22, and reconstruction module 24, or a sub-combination thereof.

In still other embodiments, a system 10 may include one or more multipurpose processors and one or more dedicated processors. For example, one or more processors of a system 10 may both perform computation corresponding to a system 10 and run gesture recognition software that utilizes the map 30 output by the system 10, while one or more other processors strictly perform computational tasks corresponding to a pulse generation module 20, transduction module 22, reconstruction module 24, or a combination thereof.

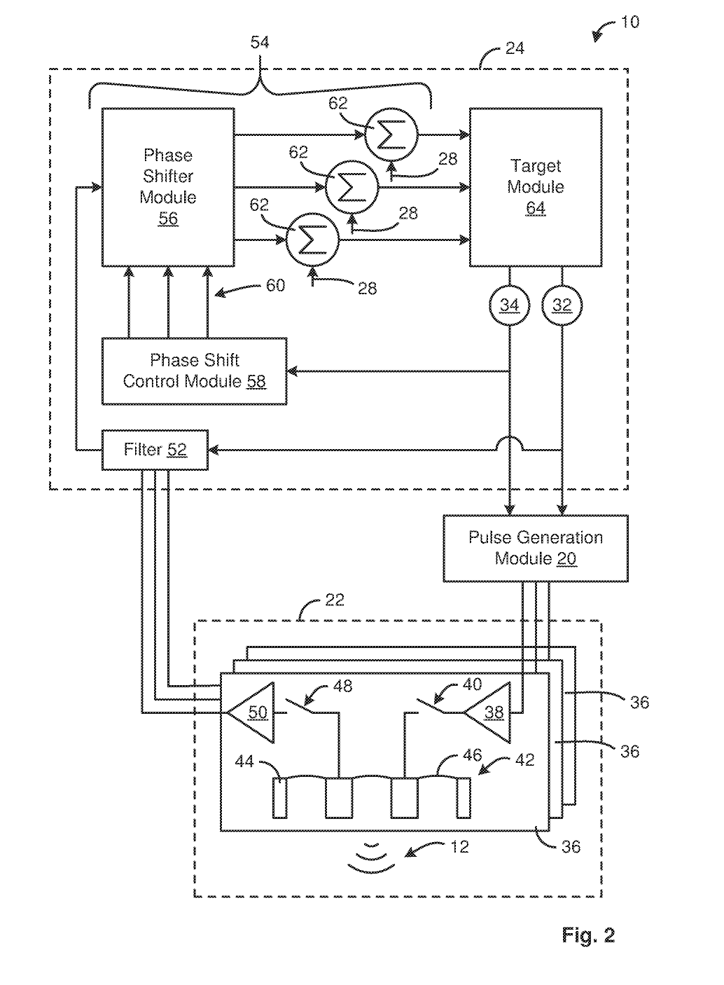

Referring to FIG. 2, in selected embodiments, a transduction module 22 may comprise an array of transmitters 36. Accordingly, transmit signals 26 output by a pulse generation module 20 may be directed to the array of transmitters 36. Each transmit signal 26 may be directed to a different transmitter 36. Within a transmitter 36, a transmit signal 26 may be amplified by an amplifier 38, pass through a transmit switch 40, and reach one or more transducers 42.

In selected embodiments, one or more transducers 42 may reside on a single substrate 44. For example, each transducer 42 may comprise a thin membrane 46 that is much thinner than the substrate 44 supporting it. The membrane 46 may be actuated using piezoelectric transduction, capacitive transduction, thermal actuation, or the like. Actuation may cause the membrane 46 to deflect out of the plane of the substrate 44, which motion may generate a sound wave.

In certain embodiments, one or more transducers 42 may be ultrasonic transducers comprising a circular unimorph membrane 46 made up of a piezoelectric material sandwiched between two electrodes with an additional bending layer above or below the piezoelectric sandwich. Aluminum nitride, lead zirconate titanate, zinc oxide, or other piezoelectric materials may be used as the piezoelectric material. An additional layer of the piezoelectric material may also be used as the bending layer, or other materials such as silicon or silicon dioxide may be used.

A voltage applied between the electrodes may create a vertical electric field in the piezoelectric material. This may cause the piezoelectric material to expand or contract in the transverse direction, creating an out-of-plane moment that is resisted by the stiffness and inertia of the membrane 46 and the acoustic impedance of the medium. The resulting velocity of the membrane 46 may generate a sound wave 12. Similarly, an incident pressure wave may cause the piezoelectric material to expand or contract and to create a charge imbalance that can be electrically detected and measured via the electrodes.

Each transducer 42 may have a center frequency at which it transduces sound most efficiently and a full-width at half maximum (FWHM) bandwidth around that center frequency at which the response is half of the maximum amplitude. In selected embodiments, each transducer 42 may emit and/or receive sound waves having a central frequency in the range from about 10 kHz to about 1 MHz. The FWHM bandwidth may be in the range of about 0.1 kHz to about 100 kHz from the central frequency. When multiple transducers 42 are used in an array to transmit and/or receive, the central frequency of each of the multiple transducers 42 may be substantially the same. Additionally, the spacing between neighboring transducers 42 may be less than the wavelength equal to the speed of sound divided by the central frequency.

When transmitting, a transmitter 36 may excite one or more transducers 42 thereof with a voltage signal near the resonance of the one or more transducers 42. In selected embodiments, a transmitter 36 may include a circuit (not shown) to determine the resonant frequency of the one or more transducers 42. A transmit switch 40 may isolate the one or more transducers 42 from the rest of the transmitter 36 during the time when the one or more transducers 42 are not transmitting.

In selected embodiments, certain transducers 42 may be used for transmission of sound waves and certain other transducers 42 may be used for reception of sound waves. Accordingly, a transduction module 22 may have an array of transmitters 36 and an array of receivers. Alternatively, certain transducers 42 may be used to both transmit and receive sound waves. In such embodiments, an array of transmitters 36 may actually be an array of transceivers.

For example, in the illustrated embodiment, when a receive switch 48 is closed, one or more transducers 42 may be set to receive. That is, transmit and receive switches 40, 48 may enable one or more transducers 42 to be both part of a transmitter 36 and part of a receiver (e.g., part of a transceiver). When transmitting, a transmit switch 40 may be closed and a receive switch 48 may be open. When receiving, a transmit switch 40 may be open and a receive switch 48 may be closed. In certain embodiments or situations, one or more transducers 42 may be used to transmit and receive simultaneously. In such embodiments or situations, a transmit switch 40 and a receive switch 48 may be closed.

When in a receiving mode, an echo 18 may arrive at one or more transducers 42 (i.e., after a delay corresponding to the range to the reflecting target 16) and mechanically oscillate one or more membranes 46 corresponding thereto. The one or more transducers 42 may convert this motion into electronic echo signals 28. In selected embodiments, a transducer 42 may continue to receive until the elapsed time since an emitted pulse 12 began exceeds twice the maximum desired range of the system 10 divided by the speed of sound. A new measurement cycle (e.g., the emitting of a new pulse 12) may begin at any time thereafter.

In certain embodiments, once received, one or more echo signals 28 may be passed through an amplifier 50 that amplifies the signal 28 and may optionally convert the signal to a digital representation. Each transducer 42 used to receive echoes 18 may have its own receive switch 48 and amplifier 50. In selected embodiments or situations, echo signals 28 may then be filtered by an adaptive filter 52. The filter 52 may adjust the filter parameters according to the range 32 to a target 16. A bandwidth of a filter 52 may be adjusted to match that of the transmit signal 26. In certain embodiments, a filter 24 may be implemented as or comprise a matched filter.

In selected embodiments, a filter 24 may be configured to pass a certain portion of an echo signal 28 corresponding to the TOF associated with measured range 32. For example, a filter 24 may selectively amplify signals within a certain duration (e.g., 100 microseconds, 500 microseconds, or 1 millisecond) before and after the previously estimated TOF. A filter 24 may be configured to selectively reject echo signals 28 which fall outside of the certain duration before and after the previously estimated TOF.

Subsequently, echo signal 28 may be passed to a digital beamformer 54. Within a beamformer 54, certain echo signals 28 may be phase-shifted by different amounts by a phase shifter module 56 and then summed with other echo signals 28 from other transducers 42 having similar receive channels to that described hereinabove. A phase shifter module 56 may be controlled by a phase shift control module 58. A phase shift control module 58 may control a phase shifter module 56 to implement a vector of phase shifts that correspond to the estimated direction 34 to a target 16.

For example, in selected embodiments, a phase shifter module 56 may be controlled by phase shift control module 58 to delay echo signals 28 by several different amounts according to a delay vector 60. Echo signals 28 acquired by other transducers 42 (i.e., echo signals 28 from “other channels”) that have already gone through the processing steps described hereinabove may be added to the echo signals 28 from a phase shifter module 56 by adders 62. The result may then be sent to a target module 64, which may output a map 30, range information 32, direction information 34, or the like.

Each of the delays in a delay vector 60 may delay an echo signal 28 by an amount corresponding to a direction in space and a location of a transducer 42. Each delay in delay vector 60 may correspond to a different direction in space. The range of angles corresponding to a delay vector 60 may form the measurement field of view. Each signal leaving an adder 62 may be an intensity vs. range measurement (e.g., an “A-scan”) for a specific direction of view. If a transmit signal 26 is isotropic, an entire field of view may be captured with a single measurement cycle, and the desired field of view and angular resolution may determine the size of the delay vector 60, the number of adders 62, and the number of echo signals 28 processed by target module 64.

A target module 64 may track a location of one or more targets 16. In selected embodiments, a target module 64 may use kinematics to constrain the velocity of one or more targets 16. For example, if a target 16 is a hand, a velocity larger than several meters per second would not be expected. Accordingly, between measurements, a position of the target 16 should not change by more than the maximum expected velocity multiplied by the measurement period. In certain embodiments, a target module 64 may use equalization techniques to improve the resolution of multiple targets 16. Such techniques may be adaptive in nature, based on the range, direction, and amplitude reflected in the echo signals 28.

In selected embodiments, a target module 64 may threshold A-scan signals to determine which echo signals 28 actually contain or capture echoes 18. Echo signals 28 that actually contain echoes 18 may be processed to determine the range and direction to one or more targets 16. The range 32 to each target 16 may be measured by determining the delay between the transmit pulse 12 and the time when an echo signal 28 has reached half of its maximum amplitude, and using the fact that the range is half the measured time multiplied by the speed of sound through the corresponding environment.

The direction 34 to each target 16 may be coarsely determined by finding the maximum of the A-scan measurements, and using the direction represented by that A-scan measurement as the direction 34 to the target 16. A more accurate estimation can be made by comparing the phase of each received echo signal 28 to a reference clock. Phase differences between channels may be used to determine the direction 34 to each target 16.

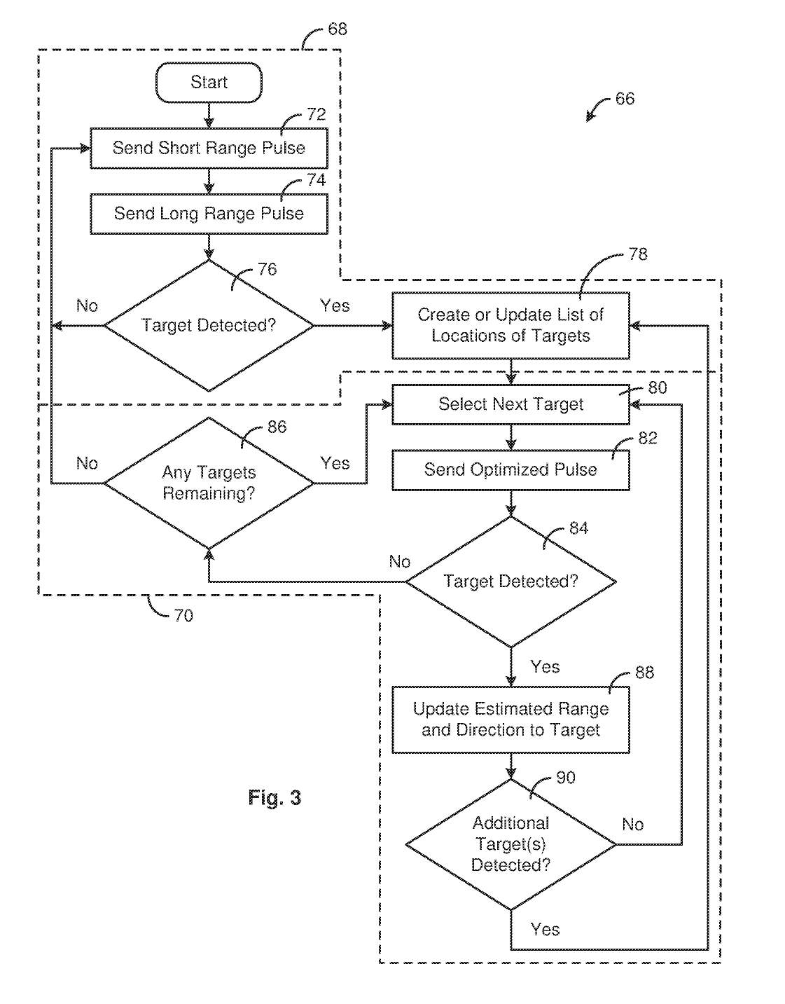

Referring to FIG. 3, a rangefinding process 66 in accordance with the present invention may be broadly characterized as a two-step procedure. In a first step 68 or target-acquisition process 68, an inventory of targets 16 within a scene 14 may be created using non-adaptive ranging operations. In a second step 70 or target-tracking process 70, a location of each target 16 may be tracked using pulses 12 that are adapted and designed to illuminate the targets 16 with increased energy and adaptive signal processing may be used to increase the processing gain of the receiver circuit.

For example, in a start phase, no information about any targets 16 may be known. Accordingly, a short pulse 12 may be sent 72. Thereafter, a long pulse 12 may be sent 74. Alternatively, a long pulse 12 may be sent 74 first, followed by a short pulse 12. In still other embodiments or situations, only a single short pulse 12 or long pulse 12 may be sent 74.

A short pulse 12 may be well suited to detect one or more targets 16 that are relatively close to a transmitter 36. For example, a short pulse 12 may have a duration less than or equal to the time required for sound to travel a distance through the corresponding environment that is equal to twice the minimum range expected or permitted for a target 16 within a scene 14. In selected embodiments, that minimum range may be somewhere between about 1 mm and about 200 mm. In other embodiments, the minimum range may be somewhere between about 10 mm and about 50 mm.

A long pulse 12 may be well suited to detect one or more targets 16 that are relatively far from a transmitter 36. In selected embodiments, a long pulse 12 may have a duration that is significantly greater (e.g., more than 50% greater, more than 100% greater, more than 200% greater, more than 1000% greater, or more than 10000% greater) than the time required for sound to travel a distance through the corresponding environment that is equal to twice the minimum range expected or permitted for a target 16 within a scene 14. Accordingly, by using both short and long pulses 12, an entire scene 14 may be thoroughly searched for targets 16.

Both long and short pulses 12 may have or comprise a narrow beam with maximum amplitude in a desired direction. In selected embodiments, one or more transducers 42 in an array may be controlled by a pulse generation module 20 to create a narrow beam and to steer that beam in a desired direction. Furthermore, in certain embodiments, the desired steering direction may be changed during the transmission to increase the Field of View (FOV) illuminated by the transducer 42 during a single pulse 12.

If a target 16 is not detected 76 by the short and long pulses 12, the process 66 may start again after an optional delay. If one or more targets 16 are detected 76, the range 32 and direction 34 to the one or more targets 16 may be estimated based on one or both of the short and long pulses 12 in order to create 78 a list of locations of targets 16.

A target 16 may then be selected 80 from the list and an optimized pulse 12 may be sent 82 toward that target 16. A pulse 12 that is optimized may have (1) a duration equal to or less than (e.g., in the range of about 97% to about 25% of, in the range of about 90% to about 25% of, or less than 25% of) the time delay (e.g., TOF) expected in view of the range 32 estimated and/or (2) a direction corresponding to the direction 34 estimated. Alternatively, a pulse 12 that is optimized may illuminate multiple targets 16 or all of the targets 16 on the list. In selected embodiments, this may be accomplished by changing the steering direction during the transmission to increase the Field of View (FOV) illuminated by the transducer 42 during a single pulse 12.

If the target 16 is not detected 84 near the expected location, and there are no targets remaining 86 on the target list, then the process 66 may return to a target-acquisition process 68 comprising short and/or long pulses 12. If a target is detected 84, then the estimated range and location to the target is updated 88. Also, if one or more additional targets 16 are detected 90, then the list of locations of targets 16 may be updated 78 to reflect the one or more additional targets 16. If no additional targets 16 are detected 90, the process 66 may move on and a next target 16 of the list may be selected 80.

While at least one target 16 is detected 76, 84, 90, that at least one target 16 may be tracked continuously over the course of several measurements by comparing a current location of the at least one target 16 to one or more previous locations of the at least one target 16. In selected embodiments, an order of targets 16 on the list and/or a manner in which the targets 16 are illuminated and measured may be optimized based on a variety of parameters such as distances between targets 16 so that a most efficient range finding operation for all the targets 16 and across the full FOV may be achieved.

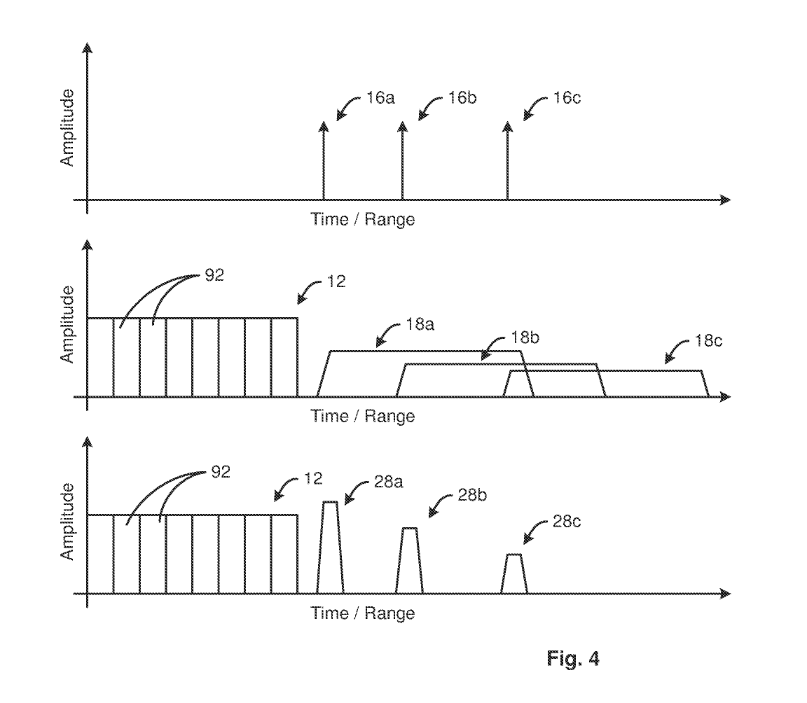

Referring to FIG. 4, a long pulse 12 may be well suited to applying significant ultrasonic energy to targets 16 that are deeper within a scene 14. However, long pulses 12 may have or result in poor axial resolution. Accordingly, in selected embodiments, one or more long pulses 12 in accordance with the present invention may be coded to enable better axial resolution thereof.

For example, in selected embodiments, a long pulse 12 may coded to include one or more phase changes or modulations therein. In other embodiments, a long pulse 12 may be coded to include one or more changes or modulations in amplitude or frequency. In still other embodiments, other types of changes or combinations of changes (e.g., combinations or sub-combinations of phase, amplitude, and frequency changes) may be coded into a long pulse 12. Such changes may encode a sequence of discrete or continuous symbols which causes the pulse 12 to have desirable autocorrelation properties.

In some embodiments, situations, or applications, a frequency modulated pulse 12 may provide, enable, or support a sharp autocorrelation peak to increase axial resolution. In such embodiments, the frequency modulation may substantially cover the entire bandwidth of one or more corresponding ultrasonic transducers 42. In other embodiments, a series of symbols (e.g. a code) designed to have a sharp autocorrelation may be used to increase the axial resolution. The symbols may comprise changes in phase, frequency, amplitude, or a combination thereof and may form a sequence such as a Barker code, a pseudo-random code, or a Gold code. The symbols may have a length such that substantially the full bandwidth of one or more corresponding transducers 42 is used.

In FIG. 4, three exemplary targets 16a, 16b, and 16c are located at increasing range from a rangefinder. Assuming the ranges 32 to the three targets 16a, 16b, and 16c have already been estimated, a pulse 12 may be generated. The pulse 12 may be less than (e.g., slightly less than) or equal to the time required for sound to travel a distance through the corresponding environment that is equal to twice the range 32 to the closest target 16a. The pulse 12 may comprise a series of coded pulses 92, where the series of pulses 92 may have desirable autocorrelation properties.

The returning echoes 18a, 18b, and 18c, may spatially overlap. However, after correlation with a signal (e.g., transmit signal 26) corresponding to the transmit pulse 12, the width reflected in the corresponding echo signals 28a, 28b, and 28c may be narrowed to substantially the width of a coded pulse 92. Accordingly, the targets 16a, 16b, and 16c may not overlap and may, therefore, be discretely identified within the echo signals 28a, 28b, and 28c.

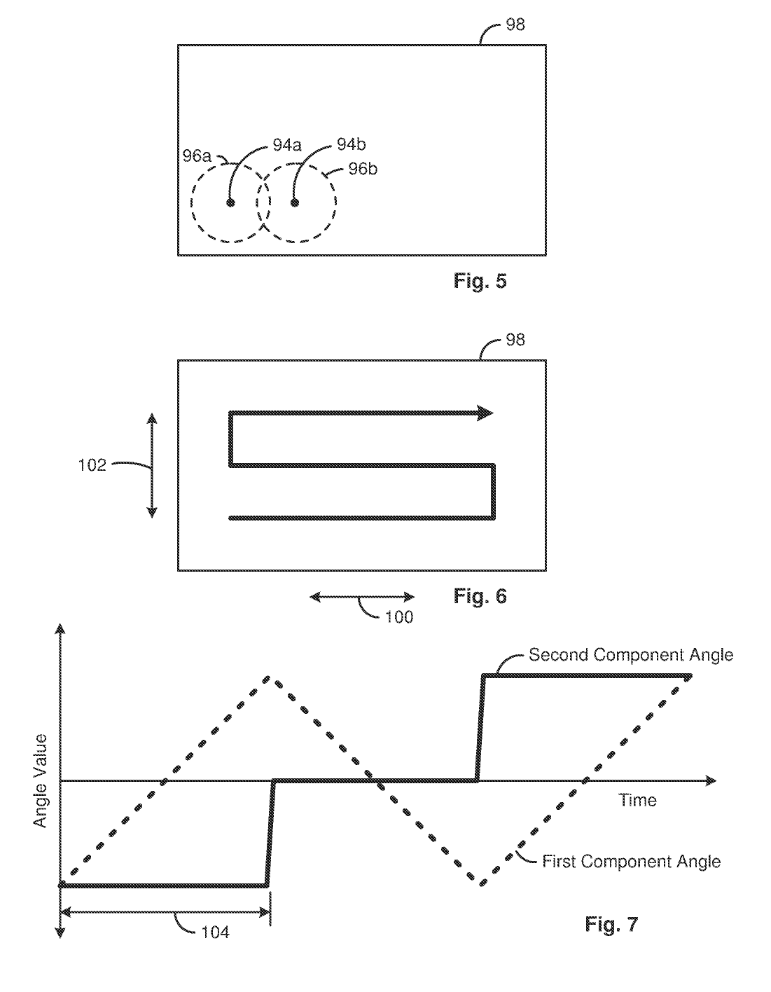

Referring to FIGS. 5-7, a phased array of transducers 42 may steer a transmit pulse 12. Such steering may be applied to one or more pulses 12 (e.g., short and/or long pulses 12) of a target-acquisition process 68, one or more pulses 12 (e.g., one or more optimized pulses 12) of a target-tracking process 70, or both. In certain embodiments, a system 10 may transmit (i.e., steer) a pulse 12 along a first axis 94a to illuminate a first space 96a. The system 10 may then receive echoes 18 from targets 16 along that first axis 94a. Thereafter, the system 10 may transmit (i.e., steer) a pulse 12 along a second axis 94b to illuminate a second space 96b, then receive echoes 18 from targets 16 along that second axis 94b. This process may be repeated until an entire FOV 98 has been canvassed.

Alternatively, a system 10 in accordance with the present invention may employ a faster method for canvassing a FOV 98. For example, in certain embodiments, a steering direction or angle may be changed during the transmission of a pulse 12. This may enable all (or at least a greater portion) of a FOV 98 to be illuminated by the transducer 42 during a single pulse 12.

As shown in FIGS. 6 and 7, a beam steering direction or angle may be swept in two dimensions. For example, a steering angle may have two component angles, namely a first component angle and a second component angle. A first component angle may correspond to a first axis 100 or direction 100. A second component angle may correspond to a second axis 102 or direction 102 that is substantially orthogonal to the first axis 100 or direction 100. Accordingly, a first component angle may be swept during the transmission of a pulse 12, while a second component angle is held constant. After a certain time 104, the pulse 12 may have swept across a FOV 98. Accordingly, the second component angle may be incremented and the pulse 12 may be swept back across a FOV 98. This may continue until a FOV 98 has been canvassed. With scenes 14 having relatively large maximum ranges, this sweeping method may be faster by a factor of about fifty or more over the method illustrated in FIG. 5.

In certain embodiments or application, a transmit pulse 12 may not be long enough in duration to sweep across an entire FOV 98 in two axes 100, 102. Accordingly, in such embodiments or applications, a system 10 may sweep across and illuminate a subset of the total FOV 98 during or with a first pulse 12 and then sweep across and illuminate other portions (e.g., the rest) of the FOV 98 during or with one or more subsequent pulses 12. Accordingly, after multiple pulses 12, an entire FOV 98 may be illuminated.

Alternatively, or in addition thereto, when an inventory of targets 12 has already been created 78, a transmit pulse 12 may be configured to only sweep across and illuminate those directions where targets 16 are expected to be present. For example, a system 10 may identify a path (e.g., an optimized or shortest distance path) through each area where known targets 16 are expected to be present. Such a path may be significantly shorter (and, therefore, significantly faster to illuminate) than a path canvassing an entire FOV 98.

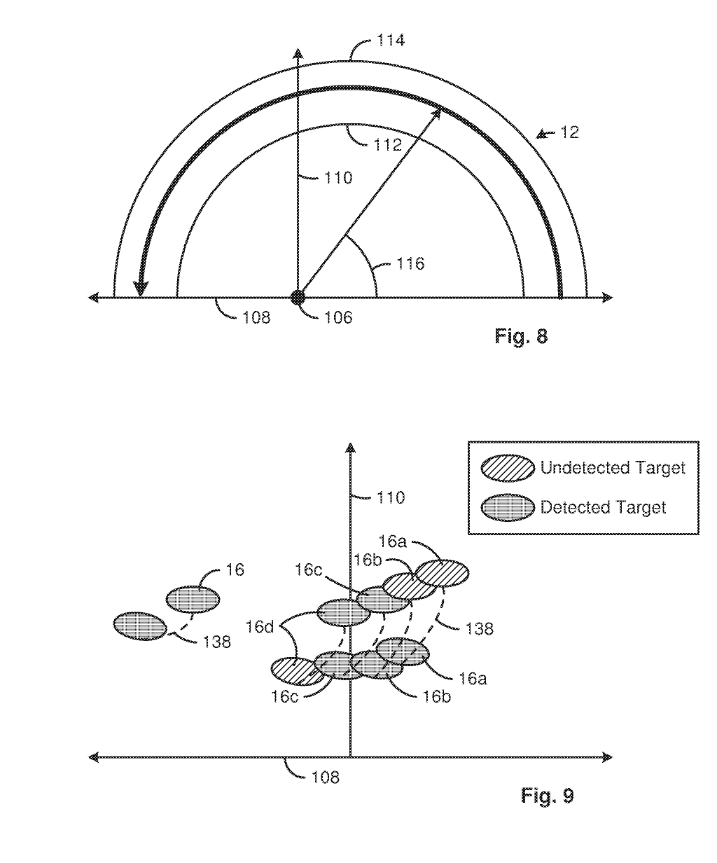

Referring to FIG. 8, in selected embodiments, a pulse 12 may be swept so that the pulse 12 propagates radially from a single axis (e.g., an axis 106 extending into the page). In the illustrated snapshot in time, a transmit pulse 12 is propagating through space in two dimensions 108, 110. The inner and outer bounds 112, 114 of the pulse 12 may represent or delineate the area in space where the amplitude of the transmitted wave is maximal.

At the time illustrated, an array of transducers 42 has finished transmitting and a pulse 12 is propagating away the array. At the beginning of the transmit cycle, the transmit signal 26 may be configured to sweep the direction of maximum amplitude such that the pulse 12 propagating in each direction is long enough in duration to be received by a receiver on reflection. The pulse 12 may initially be steered at an angle 116 nearly perpendicular to the normal axis 110 of the array (i.e., where the value of the angle 116 is nearly zero). The steering angle 116 may be increased (e.g., to a maximum of about) 180° as time increases.

Since the steering angle 116 may vary as a function of time, a time difference (T1) between the time the pulse 12 began and the time at which an echo 18 is received may be a function of the range and the angle to the target 16. To calculate the true time of flight (TOF) indicative of the range to the target 16, a system 10 may measure a direction of arrival of the received echo 18. This direction may then be used to find the time delay (T2) between the time the pulse 12 began and the time when the pulse 12 was steered to that direction. Thereafter, the TOF may be calculated as T1 less T2.

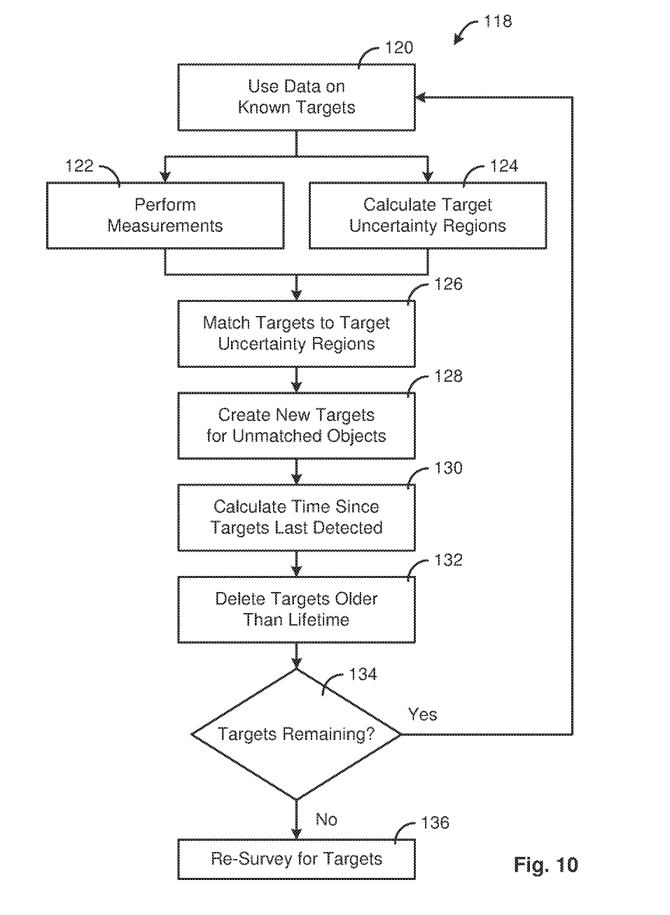

Referring to FIGS. 9 and 10, a target tracking algorithm 118 or process 118 may be used to update 78, 88 the list of target locations. In selected embodiments, such a process 118 may begin with using 120 data on known targets 16 to (1) perform 122 new measurements and (2) calculate 124 uncertainty regions for each known target 16. An uncertainty region for each known target 16 may be defined based on the product of a maximum velocity (e.g., maximum expected velocity) of the target 16 and the time elapsed between the new measurements and a previous measurement. Accordingly, an uncertainty region may define how far in any direction a known target 16 may have moved from its last known location.

Subsequently, each target 16 identified in the new measurement may be matched 126 to a target uncertainty region. Targets 16 that are not located within any uncertainty region may be classified 128 as new targets 16. An elapsed time since each target 16 was detected may then be determined 130. Targets 16 that have not been detected for a certain lifetime may be removed 132 from the list of active targets 16. A lifetime of a target 16 may be based on the amplitude of the echo 18 associated with the target 16. Accordingly, targets 16 that produce an echo 18 with greater amplitude may have a longer lifetime. Conversely, targets 16 that produce an echo 18 with lower amplitude may have a shorter lifetime.

If targets 16 remain 134 on the list, the process 118 may repeat. If no targets 16 remain 134 on the list, a scene 14 may be re-surveyed 136 for targets 16. In selected embodiments, such re-surveying 136 may comprise an exit from a target-tracking process 68 and a return to a target-acquisition process 68.

By way of example, several targets 16 (i.e., target A, target B, target C, target D, and target E) are initially detected in a two dimensional space defined by two axes 108, 110. In order to resolve multiple targets 16 as separate targets 16, various equalization techniques may be employed to increase the resolution of a system 10 in accordance with the present invention. Such techniques may include post-emphasis to increase the effective bandwidth. A system 10 may also compare a beamwidth of an echo 18 to a theoretical beamwidth of the system 10 and classify the echo 18 as originating from multiple targets 16 if the measured beamwidth is substantially larger than the theoretical beamwidth.

For each separately detected target 16, an amplitude, location, and time of detection may be recorded. In subsequent measurements, the positions of targets 16 may be observed to travel along trajectories 138. One or more targets 16a, 16b may not be detected immediately. When these targets 16a, 16b are detected, they may be outside of the uncertainty regions of one or more other targets 16c, 16d. Accordingly, the targets 16a, 16b may be classified as separate targets 16.

One target 16d may be detected at first, but after a certain time may no longer be detected. Its position may be known to be correlated with another target 16c. Accordingly, its uncertainty region may be translated along with the uncertainty region of that target 16c. After a certain lifetime, if such a target 16d is not detected again, it may be removed from the list of targets 16.

U.S. Patent Application Publication No. 2014/0253435 published Sep. 11, 2014 for Boser et al. is hereby incorporated by reference.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for acquiring and tracking targets, the method comprising:
executing, by a rangefinding system, a target-acquisition process comprising
transmitting one or more ultrasonic pulses, and
listening for one or more echoes corresponding to the one or more ultrasonic pulses;
repeating, by the rangefinding system, the target-acquisition process when the listening reveals no targets; and
exiting, by the rangefinding system, the target-acquisition process and executing, by the rangefinding system, a target-tracking process when the listening reveals at least one target, the target-tracking process comprising iteratively
transmitting an optimized ultrasonic pulse having a duration in a range of about 25% to about 97% of a time-of-flight expected for the at least one target based on at least one of the target-acquisition process and a previous iteration of the target-tracking process,
listening for at least one echo corresponding to the optimized ultrasonic pulse, and
calculating, based on the at least one echo, an updated location for the at least one target.

2. The method of claim 1, wherein the target-acquisition process is a non-adaptive rangefinding process.

3. The method of claim 1, wherein the target-tracking process is an adaptive rangefinding process.

4. The method of claim 1, wherein the transmitting the optimized ultrasonic pulse further comprises steering, by a phased array of the rangefinding system, the optimized ultrasonic pulse toward the at least one target.

5. The method of claim 4, wherein the steering comprises sweeping the optimized pulse along a shortest path through areas where each target of the at least one target is expected to be present.

6. The method of claim 1, wherein the optimized ultrasonic pulse is coded to include one or more changes in phase, amplitude, or frequency.

7. The method of claim 1, wherein the target-tracking process further comprises filtering based on a previous range measurement resulting from at least one of the target-acquisition process and a previous iteration of the target-tracking process.

8. The method of claim 7, where the filtering is sensitive to certain time delays in the at least one echo signal that correspond to the previous range measurement.

9. The method of claim 7, where the filtering is adapted to the optimized ultrasonic pulse.

10. The method of claim 9, where the filtering comprises employing a matched filter.

11. The method of claim 1, wherein the transmitting the one or more ultrasonic pulses comprises:
transmitting a shorter ultrasonic pulses having a first duration, and
transmitting a longer ultrasonic pulse having a second duration that is at least 50% greater than the first duration.

12. The method of claim 11, wherein the target-acquisition process further comprises changing a steering angle corresponding to the shorter ultrasonic pulse during the transmitting thereof.

13. The method of claim 11, wherein the target-acquisition process further comprises changing a steering angle corresponding to the longer ultrasonic pulse during the transmitting thereof.

14. The method of claim 11, wherein the longer ultrasonic pulse is coded to include one or more changes in phase, amplitude, or frequency.

15. The method of claim 11, wherein the target-acquisition process further comprises:
changing a steering angle corresponding to the short ultrasonic pulse during the transmitting thereof; and
changing a steering angle corresponding to the long ultrasonic pulse during the transmitting thereof.

16. The method of claim 15, wherein the longer ultrasonic pulse is coded to include one or more changes in phase, amplitude, or frequency.

17. The method of claim 15, wherein the target-acquisition process is a non-adaptive rangefinding process and the target-tracking process is an adaptive rangefinding process.

18. The method of claim 17, wherein the optimized ultrasonic pulse is coded to include one or more changes in phase, amplitude, or frequency.

19. The method of claim 17, wherein the transmitting the optimized ultrasonic pulse further comprises steering, by a phased array of the rangefinding system, the optimized ultrasonic pulse toward the at least one target.

20. A rangefinding system comprising:
at least one processor;
memory operably connected to the at least one processor; and
the memory storing instructions that, when executed, cause the rangefinding system to:
iterate a target-acquisition process until at least one target is identified, the target-acquisition process comprising
transmitting one or more ultrasonic pulses,
listening for one or more echoes corresponding to the one or more ultrasonic pulses;
iterate a target-tracking process after at least one target has been identified in the target-acquisition process, the target-tracking process comprising
transmitting an optimized ultrasonic pulse having a duration in a range of about 25% to about 97% of a time-of-flight expected for the at least one target based on at least one of the target-acquisition process and a previous iteration of the target-tracking process,
listening for at least one echo corresponding to the optimized ultrasonic pulse, and
calculating, based on the at least one echo, an updated location for the at least one target.

21. The system of claim 20, wherein the transmitting the optimized ultrasonic pulse further comprises steering, by a phased array of the rangefinding system, the optimized ultrasonic pulse toward the at least one target.

22. The system of claim 21, wherein:
the transmitting the one or more ultrasonic pulses comprises:
transmitting a shorter ultrasonic pulses having a first duration, and
transmitting a longer ultrasonic pulse having a second duration that is at least 50% greater than the first duration; and
the target-acquisition process further comprises:
changing a steering angle corresponding to the shorter ultrasonic pulse during the transmitting thereof; and
changing a steering angle corresponding to the longer ultrasonic pulse during the transmitting thereof.

23. The system of claim 22, wherein the longer ultrasonic pulse is coded to include one or more changes in phase, amplitude, or frequency.

24. The system of claim 23, wherein:
the target-acquisition process is a non-adaptive rangefinding process; and
the target-tracking process is an adaptive rangefinding process.
